(19) United States
(12) Patent Application Publication
(10) Pub. No.: US 2002/0028110 A1
(43) Pub. Date: Mar. 7, 2002

(54) Sensor for monitoring system of liner breakage at landfill

(75) Inventors: Jae Seong Rhee, Seoul (KR); Min Woo Jung, Seoul (KR)

Correspondence Address: HARRISON & EGBERT, 412 MAIN STREET, 7TH FLOOR, HOUSTON, TX, 77002, US

(73) Assignee: Korea Institute of Science and Technology

(21) Appl. No.: 09/799,292

(22) Filed: Mar. 5, 2001

(30) Foreign Application Priority Data
Sep. 5, 2000 (KR) 2000-52481

(51) Int. Cl. G21F 5/00

(52) U.S. Cl. 405/129.5

(57) ABSTRACT

The present invention relates to a sensor for detecting the location of breakage at a liner which is laid with the building of a landfill and more particularly to an application of a sensor for detecting the location of breakage at a liner in a landfill, which is remarkably resistant to the oozing water and chemical components in the soil and which is economical in the manufacture.

### FIELD OF THE INVENTION

The present invention relates to a sensor for detecting the location of breakage at a liner which is laid with the building of a landfill and more particularly to an application of a sensor for detecting the location of breakage at a liner in a landfill, which is remarkably resistant to the oozing water and chemical components in the soil and which is economical in the manufacture.

The sensor according to the invention is made of graphite which is low in resistance, good in conductivity and very durable and therefore has the merit of negligible corrosion due to the oozing water and chemical components in the soil when installed in a landfill.

### BACKGROUND OF THE INVENTION

The conventionally used sensors which are mostly made of coated metallic material tended to be corroded by the oozing water and various chemical components in the soil when they are installed in a landfill, so that they were not everlasting. In other words, the reliability for the detection could not be expected due to poor durability and corrosion and moreover economical efficiency lacked.

### SUMMARY OF THE INVENTION

The present invention was created in consideration of the circumstance as described above and thus the object of the invention is to provide a sensor for detecting the location of breakage at a landfill liner which has a good conductivity, strength and durability and specially is excellent in measurement sensitivity for the location of damage.

The above object is achieved according to a preferred embodiment of the present invention by a sensor for detecting the location of breakage at a landfill liner which includes a graphite detecting section of conductive graphite and in the form of a circle or polygon, as a means for detecting the location of breakage at a leakage blocking liner in a landfill.

Preferably it is provided that said (main) graphite detecting section further includes: a conductive sensing line, a shielding line of non-conductive polymer material covered on the sensing line, and an adhesive material of silicone adhered on the joining area between the shielding line and the main graphite detecting section, for protection against a corrosion or damage due to a possible oozing water.

### BRIEF DESCRIPTION OF THE DRAWINGS

FIG. 1 shows a schematic view of sensor according to a preferred embodiment of the invention,

FIG. 2 shows an arrangement in the form of lattice for sensors according to the invention and

FIG. 3 shows a conceptional view illustrating the method of locating the breakage at a liner in a landfill by using sensors according to the invention.

### DETAILED DESCRIPTION OF THE INVENTION

A preferred embodiment of the invention is described in detail below with reference to the accompanying drawings.

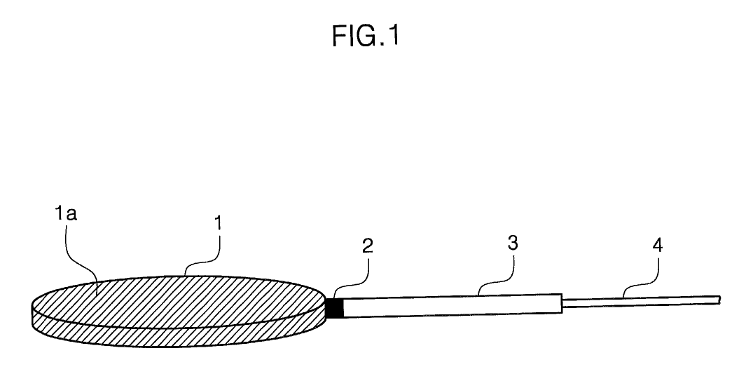

As shown in FIG. 1, a breakage location detector l(briefly ‘sensor’ in the following) comprises a graphite detecting section 1a which is preferably made of graphite, a material having low resistance and high conductivity and is in the form of a circle.

A measurement showed the resistance of the graphite detecting section 1a to be about 0.3 Ω/cm, which is negligible for the practical purpose.

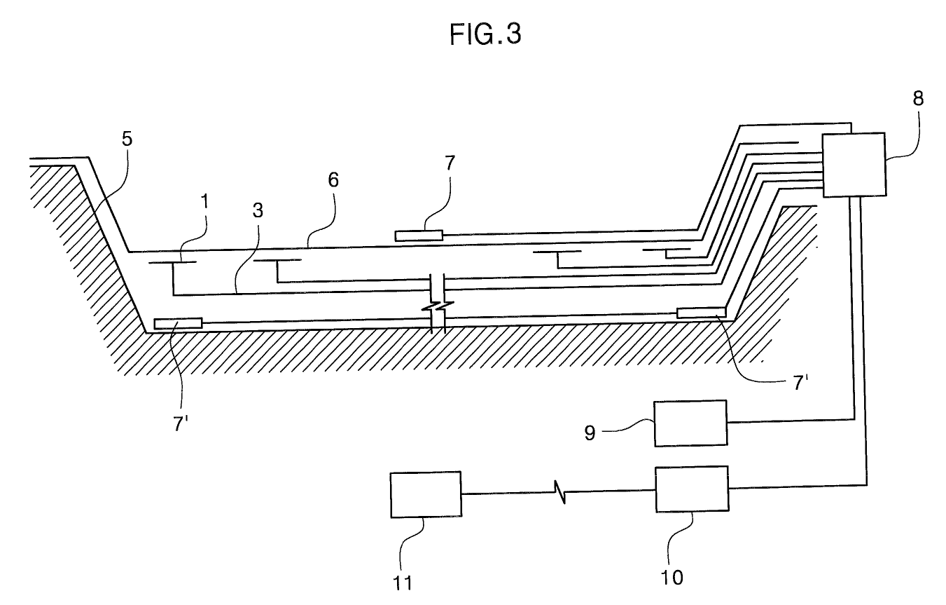

The thickness and diameter of the graphite detecting section 1a are determined in consideration of the size and condition of the field for a landfill 5 in which sensors 1 are to be provided, as shown in FIG. 3. It was found from the test result, however, that the diameter and thickness have only a minor influence on the accuracy of measurement.

Further, the graphite detecting section 1a also has the economical advantage in that it has higher durability and strength than the sensors made of metals or coated metals and the manufacturing cost is low.

On the other hand, graphite detecting sections 1a are fixedly connected to sensing lines 4, so that measured signals may be transmitted to a splitter panel 10 through a connector 8, as can be understood from FIG. 3, wherein the sensing lines 4 are preferably made of copper,

The sensing lines 4 are covered by shield lines 3 made of a non-conductive polymer material like polyvinylchloride (PVC) for protection against corrosion or damage in the landfill and the joining area between covered sensing lines 4 and graphite detection sections 1a are sealed by an adhesive 2 based on silicone to prevent a corrosion or damage by leaking water or the like.

Preferably sensors 1 may be arranged in the form of lattice in consideration of the size and shape of the landfill and the medium of the ground. The signals produced by the sensors 1 are transmitted through a connector 8 to a splitter panel 10, from which the signals reach a computer 11 via complicated measurement circuits for diagrammatic analysis.

The method of detecting any leakage of water in a liner by using the sensors 1 according to the invention is now described in more detail by referring to FIG. 3.

A plurality of power electrodes 7 and 7′ are installed respectively on above and below the leakage blocking liner 6. In the present embodiment, plural+power electrodes 7 and power electrodes 7′ are used at the ratio of 1:4.

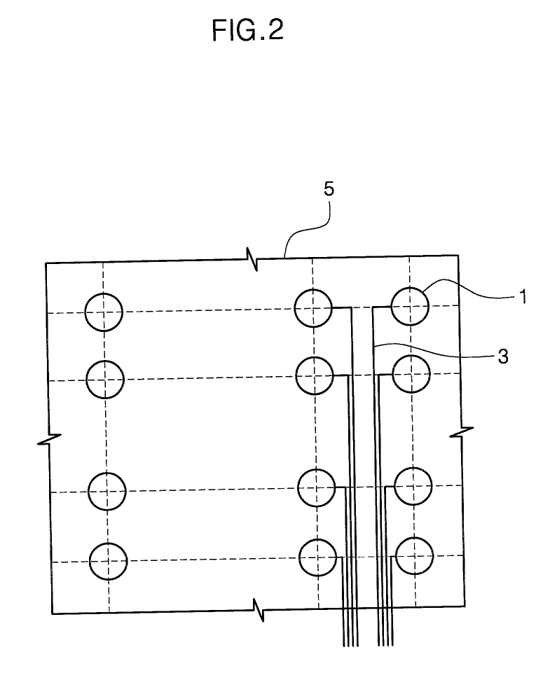

Between the power electrodes 7 and 7′ the sensors 1 according to the invention amounting to N are arranged in lattice form as shown in FIG. 2. The arrangement of the sensors 1 is appropriately decided depending on the size, shape and the kind of the ground medium.

The sensing lines 4 of the sensors 1 are connected to the connector 8, which in turn is connected to the computer 11 via the splitter panel 10. In addition, a power supplying device 9 is connected to a side of the connecter 8.

Accordingly, when power is supplied from the power supplying device 9, an electric voltage is not formed between the power electrodes 7 and 7′, as long as the liner 6 positioned therebetween is not broken.

However, if a part of the liner 6 is broken, there will be formed through that broken part a voltage drop between the power electrodes 7 and 7′, which is detected by a corresponding graphite detecting section 1a of sensor 1. The detected measurement signal is transmitted through the connecter 8 and then the splitter panel 11 to the computer 11, in which two or three dimensional diagram is displayed on a monitor so that location of breakage at the liner can be visually and numerically determined.

Here, reading is possible from the computer, in which there is recorded a program for permitting the execution of above serial steps from measurement of the location of breakage.

As elucidated above, the sensor for detecting the location of breakage according to the invention is made of graphite which is low in resistance and good in conductivity and moreover is excellent in physical strength and free of corrosion, so that it can exhibit excellent durability to an oozing water and chemical components in the soil when installed in a landfill.

Further, the low manufacturing cost provides an economical merit as well.

It is to be understood that, while the invention was described mainly with respect to a preferred embodiment of a sensor for monitoring system of liner breakage at a landfill, the invention is never restricted to that embodiment and a variety of modifications and alterations would be possible to a man skilled in the art by referring to the description or drawings presented and within the technical idea of the invention and thus those modifications or alterations are to fall within the scope of the invention, which scope should be limited only by the attached claims.

What is claimed is:

1. A sensor for detecting the location of breakage at a landfill liner which includes a graphite detecting section of conductive graphite and in the form of a circle or polygon, as a means for detecting the location of breakage at a leakage blocking liner in a landfill.

2. The sensor according to claim 1, where said graphite detecting section further includes:
a conductive sensing line,
a shielding line of non-conductive polymer material covered on the sensing line, and
an adhesive material of silicone adhered on the joining area between the shielding line and the graphite detecting section, for protection against a corrosion or damage due to a possible oozing water.

3. The sensor according to claim 2, where said sensing line is made of copper.
